(19) United States
(12) Patent Application Publication
(10) Pub. No.: US 2018/0168911 A1
(43) Pub. Date: Jun. 21, 2018

(54) System For Guiding Blind And Method Thereof

(71) Applicants: Inventec (Pudong) Technology Corporation, Shanghai (CN); Inventec Corporation, Taipei City (TW)

(72) Inventor: Chaucer Chiu, Taipei (TW)

(21) Appl. No.: 15/622,983

(22) Filed: Jun. 14, 2017

(30) Foreign Application Priority Data
Dec. 21, 2016 (CN) 201611191051.2

(51) Int. Cl. A61H 3/06; G01C 21/34; G01C 21/36

(52) U.S. Cl. CPC A61H 3/061; G01C 21/3415; A61H 2003/063; G01C 21/3652; G01C 21/3484

(57) ABSTRACT

The present disclosure illustrates a system for guiding a blind and method thereof. In the system, a portable device is electrically coupled to a walking aid device, the walking aid device generates an obstacle signal when detecting an obstacle, an obstacle determination module may determines an obstacle width and a distance from the obstacle in accordance with the obstacle signal, and a route planning module may generate a dodging route according to the obstacle width, the obstacle distance and a user step size loaded previously. As a result, the system and the method are able to let user know about information of the front obstacle, and may achieve the effect of dodging the front obstacle safely.

### CROSS-REFERENCE TO RELATED APPLICATION

This application claims the benefit of Chinese Patent Application No. 201611191051.2, filed Dec. 21, 2016.

### BACKGROUND

### Field of the Invention

The present disclosure relates to a system for guiding blind and method thereof, more particularly to a system capable of generating a dodging route according to information of obstacle and a user step size, and method thereof.

### Description of the Related Art

In recent years, with progress of technology and advanced development of humanity, people pay more attention on social welfare. For this reason, how to make it more convenient for the people with disabilities in living environment has become an increasingly-important topic. For example, it may be more convenient and helpful for blind to move or act in environment with guiding facilities, such as sound alerts provided at traffic lights or in elevators, tactile tiles disposed on sidewalks, or speech information provided by automated teller machines (ATM) or automatic ticket machines.

The guide facilities may improve convenience for the blind person in movement, but are not necessary goods. In fact, the conventional guide objects, such as white canes, guide dogs, and so on, have some drawbacks. For example, the conventional white cane may be used to only explore and touch the obstacle on ground in front of but not far away from the blind user, and it may be too late for the blind using the white cane to dodge the obstacle. Furthermore, the guide dog may have more interaction with the visually impaired person, but its feeding/training time is long and service time is short, and it is not easy for general person to afford the feeding cost of the guide dog.

In order to solve aforementioned drawbacks of the guiding objects, there are several electronic guiding devices available in market, such as an electronic guiding device using global positioning system (GPS) in cooperation with a speech system, and such electronic guiding device may inform the blind user by speech, about the user's current position, guide information of travel, or a combination thereof, but is unable to inform the blind user about the information of obstacle (such as wall, tree, vehicle parked at the roadside) which the user possibly encounters on the road. In other words, the blind using the electronic guiding device is unable to clearly understand the information about front obstacle.

According to aforementioned content, the conventional guiding objects or devices have the problems that the blind is unable to clearly understand the information about front obstacle. Therefore, what is need is to develop a new system for guiding blind, to solve aforementioned problems.

### SUMMARY

In order to solve the conventional technology problem that the blind person is unable to clearly understand the information about front obstacle, the present disclosure is to provide a system for guiding blind and method thereof.

According to an embodiment, the present disclosure provides a system for guiding blind. The system is applicable to a portable device which is configured to electrically coupled to a walking aid device, and the system includes: a data loading module configured to load a user step size; a signal receiving module configured to receive an obstacle signal generated by the walking aid device when the walking aid device detects an obstacle; an obstacle determination module configured to determine an obstacle width and a distance from the obstacle according to the obstacle signal; a route planning module configured to generate a dodging route according to the obstacle width, the distance from the obstacle, and the user step size; and an output module configured to output the dodging route.

According to an embodiment, the present disclosure further provides a method for guiding blind. The method includes following steps: electrically coupling a portable device to a walking aid device; loading a user step size into the portable device; generating an obstacle signal when the walking aid device detects an obstacle, and transmitting the obstacle signal to the portable device; in the portable device, determining an obstacle width and a distance from the obstacle according to the obstacle signal; in the portable device, generating a dodging route according to the obstacle width, the distance from the obstacle, and the user step size; and in the portable device, outputting the dodging route.

### BRIEF DESCRIPTION OF THE DRAWINGS

The structure, operating principle and effects of the present disclosure will be described in detail by way of various embodiments which are illustrated in the accompanying drawings.

FIG. 1 is a system framework diagram of a system for guiding blind, in accordance with the present disclosure.

FIG. 2A is a schematic view of an operation of calculating a distance between a user and an obstacle.

FIG. 2B is a schematic view of an operation of determining a direction of travel.

FIG. 2C is a schematic view of other operation of determining the direction of travel.

FIG. 3 is a flowchart showing the steps in an operation of the method for guiding blind.

### DETAILED DESCRIPTION OF THE PREFERRED EMBODIMENTS

The following embodiments of the present invention are herein described in detail with reference to the accompanying drawings. These drawings show specific examples of the embodiments of the present invention. It is to be understood that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be understood that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present invention. As used herein, the term “or” includes any and all combinations of one or more of the associated listed items.

A system and method of the present disclosure is able to guide a user to dodge an obstacle according to a user step size, an obstacle width and a distance between the user and the obstacle.

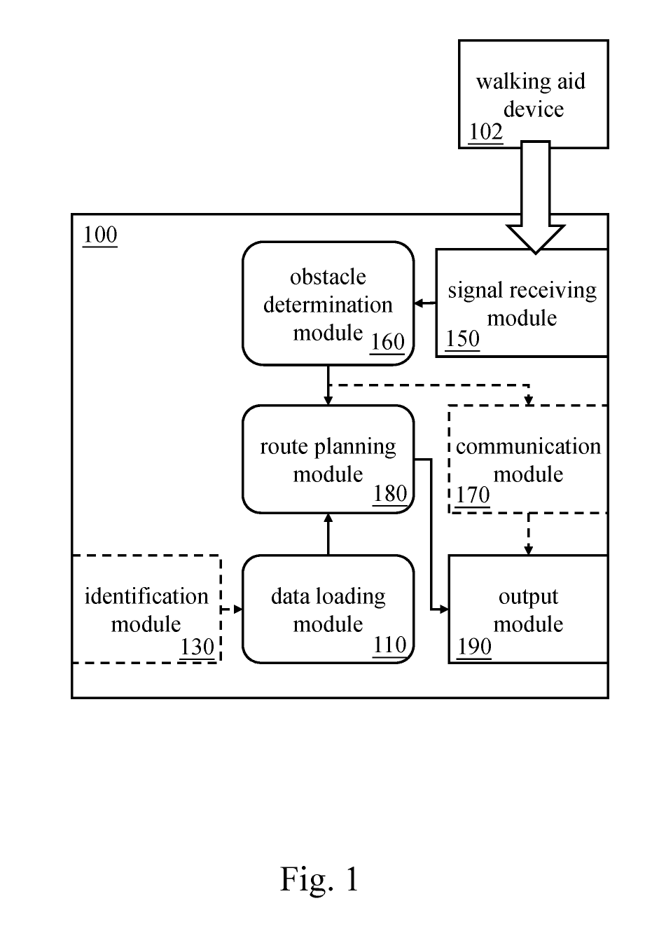

The following refers to FIG. 1, which is a system framework diagram of the system for guiding blind in accordance with the present disclosure, for illustration of an operation of the system of the present disclosure. As shown in FIG. 1, the system of the present disclosure includes a walking aid device 102 and a portable device 100. The portable device 100 may include a data loading module 110, a signal receiving module 150, an obstacle determination module 160, a route planning module 180 and an output module 190. Preferably, the portable device 100 may include an identification module 130 and a communication module 170.

The portable device 100 is electrically coupled to the walking aid device 102. For example, the portable device 100 may be electrically coupled to the walking aid device 102 through a connection wire, or through a wireless communication technology such as wireless ad hoc network, Bluetooth, or near field communication (NFC).

The portable device 100 is usually a user's carry-on device, such as a smartphone, a smart watch, an E-book reader, an electronic dictionary, a Walkman, a MP3 player, and so on. However, the present disclosure is not limited to aforementioned examples.

The walking aid device 102 is electrically coupled to the portable device 100, and configured to detect an obstacle, and generate an obstacle signal when detecting the obstacle, and then transmit the generated obstacle signal to the portable device 100. In general, the walking aid device 102 may include a sensor capable of emitting and receiving an energy signal, and then generate the obstacle signal upon receipt of a reflected signal corresponding to the emitted energy signal. Preferably, the energy signal may be an infra-red signal or an ultrasonic signal, but the present disclosure is not limited thereto.

In some embodiments, the sensor included in the walking aid device 102 may continuously emit the energy signal by different angles, and continuously receive the reflected signal which is generated after the emitted energy signal with many angles is in contact with the obstacle, so that the sensor generates the obstacle signal according to the reflected signal. However, the manner that the walking aid device 102 generates the obstacle signal is not limited to aforementioned example. The obstacle signal generated by the walking aid device 102 may include an angle by which the energy signal is emitted and a distance from the obstacle, or include the angle by which the energy signal is emitted and distance calculation data which may be sufficiently used to calculate the distance from the obstacle. For example, the distance calculation data may be a time difference between when the energy signal is emitted and when the reflected signal corresponding to the emitted energy signal is received.

The walking aid device 102 may be apparel, wear goods or a handheld object (such as a hat, a coat, a pair of shoes, a watch, a belt, a white cane, and so on) which is provided with the sensor for detecting the obstacle. However, the walking aid device 102 of the present disclosure is not limited to aforementioned examples. It is worth noting that in the present disclosure the number of the walking aid device 102 is not limited to one, that is, the system may include multiple walking aid devices 102 to detect the obstacle, in the present disclosure. Furthermore, when there are multiple walking aid devices 102 electrically coupled to the same portable device 100, the multiple walking aid devices 102 may be separately used to detect the obstacle in different orientation, for example, the multiple walking aid devices 102 may separately detect the obstacle in front of, above, on the left side of, on the right side of, and behind the user.

The data loading module 110 is configured to load a user step size. In general, the user step size may be loaded into the data loading module 110 in advance, and the data loading module 110 may read the user step size stored in advance; however, the manner of loading the user step size into the data loading module 110 is not limited to aforementioned manner. The data loading module 110 may provide a user interface for the user to input the user step size, or the data loading module 110 may calculate the user step size according to vibration sensing data generated by a vibration sensor disposed in the portable device 100 and position sensing data generated by a position sensor disposed in the portable device 100, thereby loading the user step size. In detail, the data loading module 110 may determine the number of the user's walking steps according to regularity of the vibration sensing data generated by the vibration sensor, and calculate the user's walk distance according to the position sensing data generated by the position sensor, and then calculate the user step size according to the number of steps and the calculated walk distance. However, the manner that the data loading module 110 obtains the user step size is not limited to aforementioned example. In some embodiments, the data loading module 110 may also store the calculated step size.

The data loading module 110 may store the user step size in a memory, a file or a database, but the present disclosure is not limited thereto. In some embodiments, the data loading module 110 may store one or more user step sizes. The data loading module 110 may selectively load the user step size corresponding to user identification data, which is indicative of user identity, provided by the identification module 130.

The identification module 130 may provide the user to input the user identification data, and determine the user identity according to the inputted user identification data. In general, the identification module 130 may store personally identifiable data in advance, and compare the inputted user identification data with the pre-stored personally identifiable data, and when the inputted user identification data matches any one piece of the pre-stored personally identifiable data, the identification module 130 determines the user identity according to the matched personally identifiable data. The user identification data may be indicative of the user identity, for example, the user identification data may be an account and a password, a fingerprint, a voiceprint, and so on, but the present disclosure is not limited thereto.

The signal receiving module 150 is used to receive the obstacle signal generated by the walking aid device 102 when the walking aid device 102 detects the obstacle.

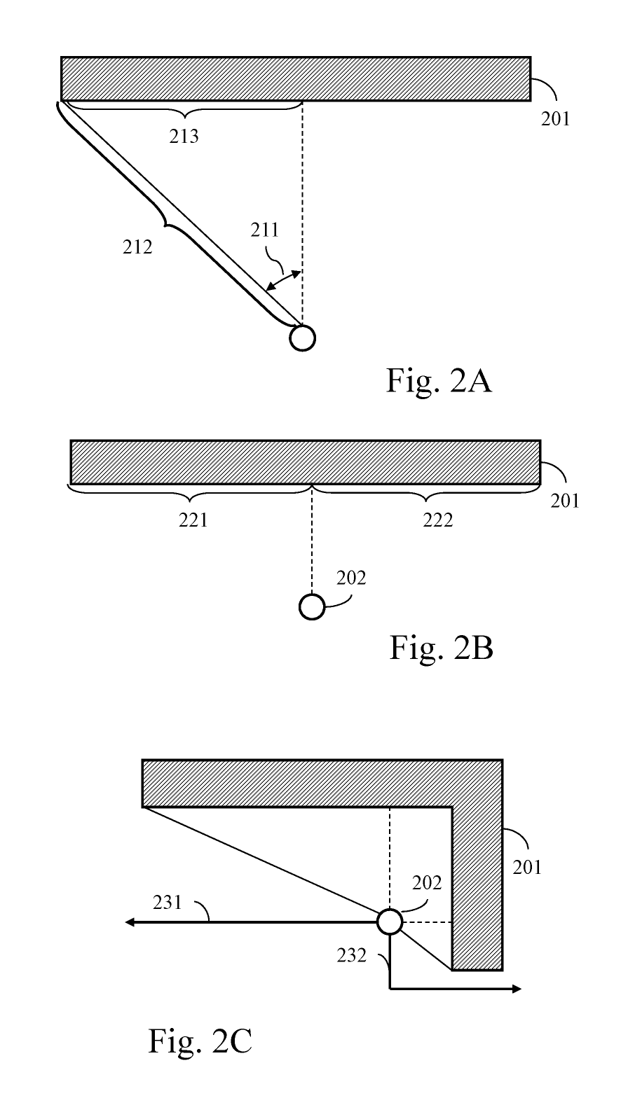

The obstacle determination module 160 is configured to determine an obstacle width and a distance from the obstacle according to the obstacle signal received by the signal receiving module 150. The obstacle determination module 160 may calculate the obstacle width according to the angle by which the energy signal is emitted and the distance from the obstacle, and the angle and the distance are included in the multiple obstacle signals. As shown in FIG. 2A, the obstacle determination module 160 may use a tangent function of trigonometric function to calculate the obstacle width 213 according to the longest distance 212 from the obstacle 201 and the angle 211 by which the energy signal corresponding to the longest distance 212 is emitted. In some embodiments, the obstacle signal received by the signal receiving module 150 may not include the distance from the obstacle, but include the distance calculation data for calculating the distance from the obstacle. In this case, the obstacle determination module 160 first calculates the corresponding distance from the obstacle according to the distance calculation data included in the obstacle signals, for example, the obstacle determination module 160 may multiply the time difference contained in the distance calculation data and speed of sound to obtain two times of the distance from the obstacle. Next, the obstacle determination module 160 calculates the obstacle width according to the angle, included in the obstacle signals, by which the energy signal emitted and the calculated corresponding distance from the obstacle.

In some embodiments, the obstacle determination module 160 may determine the obstacle. The obstacle determination module 160 may record data associated with the obstacle, such as a position, a type, a width of the obstacle, and so on. As a result, when detecting an obstacle, the obstacle determination module 160 may determine whether the detected obstacle is a known obstacle.

When the obstacle determination module 160 determines the obstacle as an intersection, the communication module 170 is linked with a traffic server (not shown in figures) to obtain current traffic sign information of the intersection which is determined as the obstacle. The traffic server may be disposed in traffic management unit or department, or on periphery of the intersection which is determined to be the obstacle. The communication module 170 may be linked with the traffic server through mobile communication network, wireless network or Bluetooth technology.

The route planning module 180 is configured to generate a dodging route according to the obstacle width and the distance determined by the obstacle determination module 160, and the user step size loaded in the data loading module 110. The dodging route generated by the route planning module 180 includes one or more data sets which each of includes a direction of travel and a number of steps of travel. For example, the data set of the dodging route may include: “walk three steps to the left”, or “walk back four steps first and then walk thirteen steps to the right”.

In general, as shown in FIG. 2B, when the obstacle 201 is located in front of the user 202, the route planning module 180 may divide the obstacle into two sections 221 and 222 by a vertical line, and then select a direction towards the section 222 with a shorter length as the direction of travel, and calculate the number of steps of travel according to the length of the shorter section 222 and the user step size, thereby generating the dodging route including the data set of the direction of travel and the number of steps of travel. When the obstacle 201 is not only located in front of the user 202 but also around the user, as shown in FIG. 2C, the route planning module 180 may calculate a distance of a route 231 to the left for bypassing the obstacle 201 and a distance of a route 232 bypassing the obstacle 201 backwards, and then select a direction of the route 232 having shorter length as the direction of travel, and calculate the number of steps of travel according to the distance of the selected route 232 and the user step size. The route 232 has a turn, so the route planning module 180 may generate the dodging route including two data sets of the direction of travel and the number of steps of travel. However, the manner that the route planning module 180 generates the dodging route is not limited to aforementioned example.

In some embodiments, according to a current position of the portable device 100, the route planning module 180 may download geographic information within a certain area from a prebuilt database or be linked to a geographic information server to download the geographic information, thereby loading the geographic information within certain area around the current position into the portable device 100. Next, the route planning module 180 may generate the dodging route according to ambient environment, terrain, floor coverings, or combination thereof around the current position in the loaded geographic information plus the obstacle width and the distance determined by the obstacle determination module 160. That is, the route planning module 180 may combine data of the obstacle, according to the obstacle width and the distance, with the loaded geographic information, so that, according to the combined geographic information and conventional route planning technology, the route planning module 180 may plan the dodging route bypassing the obstacle without directly passing through the obstacle, or the route planning module 180 may select other route to bypass the obstacle.

The route planning module 180 may also continuously adjust the dodging route according to the obstacle signal received by the signal receiving module 150. In detail, while the user is moving, when the route planning module 180 determines that the obstacle width is longer than the previously-determined obstacle width according to the obstacle signal, the route planning module 180 may adjust the dodging route according to the new-determined obstacle width and distance.

The route planning module 180 may also detect the user behavior, and selectively adjust or not adjust the generated dodging route according to severity of the detected user behavior. The detectable user behavior for the route planning module 180 includes, but not limited to, the user's voice detected by an audio sensor of the portable device 100, the user's gesture detected by the vibration sensor of the portable device 100, the user's travel speed, and so on. For example, if the route planning module 180 detects that the user makes much panic voice or overly-large gesture, or the user's travel speed is too slow or continuously changed, the route planning module 180 may determine that the current dodging route is unsuitable for the user and may plan other dodging route again.

The output module 190 is configured to output the dodging route generated by the route planning module 180. In general, the output module 190 may broadcast speech, like the conventional navigation device or software, to output each of the data sets of the direction of travel and the number of steps of travel included in the dodging route generated by the route planning module 180. However, the manner that the output module 190 outputs the dodging route is not limited to aforementioned example.

The output module 190 may also output the current traffic sign information of the intersection, which is determined as the obstacle by the obstacle determination module 160, obtained through the communication module 170. Similarly, the output module 190 may output the current traffic sign information by speech.

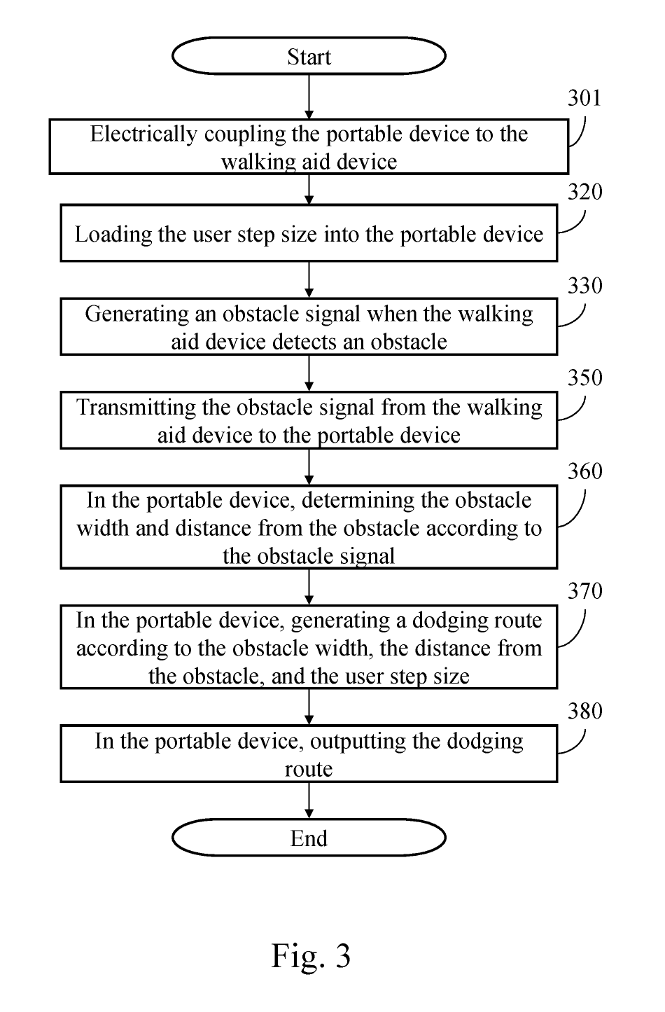

The following describes an embodiment for illustration of operation of the system and method of the present disclosure. Please refer to FIG. 3, which is a flowchart showing the steps in an operation of the method for guiding blind, in accordance with the present disclosure. In this embodiment, suppose that the user is blind, the portable device 100 is a smartphone, and the user holds a white cane which is provided with the walking aid device 102, but the present disclosure is not limited thereto.

In a step 301, in order to use the system of the present disclosure, the user needs to electrically couple the portable device 100 to the walking aid device 102. In this embodiment, suppose that the portable device 100 is electrically coupled to the walking aid device 102 through Bluetooth technology.

In a step 320, after the user operates the portable device 100 to execute an application program applying the system of the present disclosure, the user step size is loaded into the data loading module 110. In this embodiment, if the portable device 100 has recorded user step sizes of multiple users, the identification module 130 may provide the user to input user identification data and then determine the user identity according to the inputted user identification data, so that the user step size of the user corresponding to the user identity determined by the identification module 130 may be loaded into the data loading module 110.

When the user step size of the user corresponding to the inputted user identification data does not exist, the data loading module 110 of the portable device 100 may calculate the user step size according to the vibration sensing data generated by the vibration sensor of the portable device 100 and the position sensing data generated by the position sensor of the portable device 100 while the user is walking, and the calculated user step size is loaded into the data loading module 110. The data loading module 110 may also store the calculated user step size for next data loading.

After the portable device 100 is electrically coupled to the walking aid device 102 (in the step 301), the walking aid device 102 starts to continuously detect an obstacle, and in a step 330, when the walking aid device 102 detects the obstacle, the walking aid device 102 generates an obstacle signal corresponding to the obstacle. In a step 350, the walking aid device 102 transmits the obstacle signal to the portable device 100. In this embodiment, suppose that the obstacle signal generated by the walking aid device 102 includes the angle by which the energy signal is emitted, and the time difference between when the energy signal is emitted and when the reflected signal corresponding to the emitted energy signal is received.

In a step 360, after the signal receiving module 150 of the portable device 100 receives the obstacle signal transmitted from the walking aid device 102, the obstacle determination module 160 of the portable device 100 may determine an obstacle width and a distance from the obstacle according to the obstacle signal received by the signal receiving module 150. In this embodiment, the obstacle determination module 160 may calculate the obstacle width and the distance from the obstacle according to the angle by which the energy signal is emitted and the time difference between when the energy signal is emitted and when the reflected signal corresponding to the emitted energy signal is received.

In a step 370, after the obstacle determination module 160 of the portable device 100 determines the obstacle width and the distance from the obstacle, the route planning module 180 of the portable device 100 may generate a dodging route according to the obstacle width and the distance determined by the obstacle determination module 160 and the user step size loaded into the data loading module 110. In this embodiment, suppose that the obstacle is located in front of the user, the route planning module 180 may load the geographic information within a certain area according to the current position of the portable device 100, and combine the obstacle width and the distance determined by the obstacle determination module 160 with the ambient environment and/or terrain and floor coverings around the current position contained in the loaded geographic information, and then generate the dodging route according to the combined geographic information which includes the obstacle width and the distance from the obstacle. The dodging route generated by the route planning module 180 includes a data set of a direction of travel and a number of steps of travel, so that the user may horizontally move along the road away from being blocked by the obstacle.

In a step 330, when there is the obstacle in front of the user, the walking aid device 102 may continuously detect the obstacle to generate the obstacle signal, and in a step 350, the generated obstacle signal is transmitted to the portable device 100. Therefore, in a step 360, the obstacle determination module 160 of the portable device 100 may continuously determine the obstacle width and the distance from the obstacle, and in a step 370, the route planning module 180 of the portable device 100 may continuously generate and update the dodging route according to the obstacle width and the distance continuously determined by the obstacle determination module 160. As a result, the route planning module 180 does not stop generating the new dodging route until the walking aid device 102 does not detect any obstacle.

In a step 380, after the route planning module 180 of the portable device 100 generates the dodging route, the output module 190 of the portable device 100 may output the dodging route generated by the route planning module 180. In this embodiment, the output module 190 may broadcast the direction of travel and the number of steps of travel of the dodging route, which is generated by the route planning module 180, by speech; for example, the output module 190 broadcasts the speech “there is an obstacle in front, please walk thirty-five steps to the right”. The user may walk according to the speech broadcasted by the output module 190, thereby bypassing the obstacle safely. By using the system and method of the present disclosure, the user may dodge the front obstacle safely and keep walking on the traveling route.

In aforementioned embodiment, after the route planning module 180 of the portable device 100 generates the dodging route, the route planning module 180 may continuously detect the user behavior by using the vibration sensor, the audio sensor, or a combination thereof, and after the route planning module 180 detects the user behavior, the route planning module 180 selectively adjust or does not adjust the generated dodging route according to the detected user behavior.

Furthermore, in aforementioned embodiment, when the obstacle determination module 160 of the portable device 100 determines that the obstacle is the intersection, the communication module 170 of the portable device 100 may be linked to the traffic server to obtain the current traffic sign information of the front intersection, and the output module 190 of the portable device 100 may broadcast the current traffic sign information, which is obtained by the communication module 170, by speech. For example, the output module 190 may broadcast the speech “the traffic light of the front intersection is red, please stop”, “The traffic light of the front intersection is green, please move on”, and so on.

The method and system of the present disclosure may be implemented by hardware, software or a combination thereof. Furthermore, the method and system of the present disclosure may be implemented in one computer system by a centralized manner, or implemented in different components distributed in interconnected computer systems.

The present disclosure disclosed herein has been described by means of specific embodiments. However, numerous modifications, variations and enhancements can be made thereto by those skilled in the art without departing from the spirit and scope of the invention set forth in the claims.

What is claimed is:

1. A method for guiding blind, comprising:
electrically coupling a portable device to a walking aid device;
loading a user step size into the portable device;
generating an obstacle signal when the walking aid device detects an obstacle, and transmitting the obstacle signal to the portable device;
in the portable device, determining an obstacle width and a distance from the obstacle according to the obstacle signal;
in the portable device, generating a dodging route according to the obstacle width, the distance from the obstacle, and the user step size; and
in the portable device, outputting the dodging route.

2. The method according to claim 1, wherein the step of loading the user step size into the portable device further comprising:
in the portable device, calculating the user step size according to vibration sensing data generated by a vibration sensor and position sensing data generated by a position sensor, or reading the user step size which is stored in the portable device in advance.

3. The method according to claim 1, wherein the step of loading the user step size into the portable device further comprising:
in the portable device, determining a user identity according to user identification data, and loading the user step size corresponding to the user identity.

4. The method according to claim 1, wherein the step of generating the dodging route in the portable device according to the obstacle width and the distance from the obstacle further comprising:
loading geographic information within a certain area around a current position into the portable device, and generating the dodging route according to ambient environment, terrain, floor coverings or a combination thereof around the current position.

5. The method according to claim 1, after the step of outputting the dodging route, further comprising:
in the portable device, detecting a user behavior by a vibration sensor, an audio sensor, and a combination thereof, and adjusting the dodging route according to the user behavior.

6. The method according to claim 1, further comprising:
when the obstacle is determined as an intersection, linking the portable device to a traffic server to obtain current traffic sign information of the intersection, and outputting the current traffic sign information.

7. The method according to claim 1, wherein the step of outputting the dodging route further comprising:
broadcasting, in the portable device, a direction of travel and a number of steps of travel of the dodging route by speech.

8. A system for guiding blind, applicable to a portable device which is configured to electrically coupled to a walking aid device, and the system comprising:
a data loading module configured to load a user step size;
a signal receiving module configured to receive an obstacle signal generated by the walking aid device when the walking aid device detects an obstacle;
an obstacle determination module configured to determine an obstacle width and a distance from the obstacle according to the obstacle signal;
a route planning module configured to generate a dodging route according to the obstacle width, the distance from the obstacle, and the user step size; and
an output module configured to output the dodging route.

9. The system according to claim 8, wherein the data loading module calculates the user step size according to vibration sensing data generated by a vibration sensor and position sensing data generated by a position sensor, or reads the user step size which is stored in advance.

10. The system according to claim 8, wherein the portable device determines a user identity according to user identification data, and loading the user step size corresponding to the user identity.

11. The system according to claim 8, wherein geographic information within a certain area around a current position is loaded into the route planning module, and the route planning module generates the dodging route according to ambient environment, terrain, floor coverings or a combination thereof around the current position.

12. The system according to claim 8, wherein the route planning module detects a user behavior by a vibration sensor, an audio sensor, and a combination thereof, and adjusts the dodging route according to the user behavior.

13. The system according to claim 8, further comprising a communication module, and wherein when the obstacle determination module determines the obstacle as an intersection, the communication module is linked to a traffic server to obtain current traffic sign information of the intersection, and the output module outputs the current traffic sign information.

14. The system according to claim 8, wherein the dodging route comprises at least one direction of travel and the corresponding number of steps of travel of the dodging route, and the output module outputs the dodging route by broadcasting the direction of travel and the number of steps of travel by speech.
